(19) United States
(12) Patent Application Publication
(10) Pub. No.: US 2015/0106168 A1
(43) Pub. Date: Apr. 16, 2015

(54) Electronic Voting Configurator

(71) Applicant: Everyone Counts, Inc., San Diego, CA (US)

(72) Inventor: Roy Grossberg, San Diego, CA (US)

(21) Appl. No.: 14/512,225

(22) Filed: Oct. 10, 2014

Related U.S. Application Data
(60) Provisional application No. 61/889,466, filed on Oct. 10, 2013.

(51) Int. Cl. G06Q 30/00; G07C 13/00

(52) U.S. Cl. CPC G06Q 30/00; G07C 13/00; G06Q 2230/00
USPC 705/12

(57) ABSTRACT

Methods and apparatus, including computer program products, are provided for configuring electronic voting. Related systems, methods, and articles of manufacture are also disclosed.

### CROSS REFERENCE TO RELATED APPLICATION

This application claims the benefit of priority under 35 U.S.C. §119(e) of U.S. provisional patent application No. 61/889,466, entitled “Electronic Voting Configurator,” filed on Oct. 10, 2013. The contents of the above-identified application are incorporated herein by reference in their entirety.

### TECHNICAL FIELD

The subject matter described herein relates generally to data processing and, in particular, to electronic voting.

### BACKGROUND

Electronic voting refers to voting electronically. For example electronic voting may be used by voters to access a ballot via a processor, such as a personal computer. The ballot is presented electronically to allow a user to cast a vote, and then the cast ballot can be submitted electronically and/or printed and submitted with other cast ballots to determine the results of the vote. The electronic voting process can thus be used to efficiently vote for political candidates, propositions, corporate board of directors, and anything else. However, configuring an election can be complex. For example, each jurisdiction may have laws and/or rules dictating the voting and electronic voting processes including what information should be presented on a ballot, the format of the information, and other aspects related to the voting. As such, configuring electronic voting can be time consuming, require complex coding and/or configuration—thus being prone to error and delays.

### SUMMARY

Methods and apparatus, including computer program products, are provided for configuring electronic voting.

In some example embodiments, there is provided a method which includes configuring, by an electronic voting configurator, an electronic voting session including operations permitted by a voter and one or more pages presented to the voter during the electronic voting session, wherein the configuring further includes: receiving a first selection from a user interface including a login configuration page enabling configuration of a login for the voter during the electronic voting session, receiving a second selection from the user interface including a ballot configuration page enabling configuration of a ballot for presentation to the voter during the electronic voting session, receiving a third selection from the user interface including a print configuration page enabling configuration of whether printing is allowed by the voter during the electronic voting session, and receiving a fourth selection from the user interface including a logout configuration page enabling configuration of a logout for the voter during the electronic voting session; and storing, by the electronic voting configurator, the first, second, third, and fourth selections in a repository to define the operations permitted by the voter and the one or more pages presented to the voter during the electronic voting session.

Articles are also described that comprise a tangibly embodied computer-readable medium embodying instructions that, when performed, cause one or more machines (for example, computers, etc.) to result in operations described herein. Similarly, apparatus are also described that can include a processor and a memory coupled to the processor. The memory can include one or more programs that cause the processor to perform one or more of the operations described herein.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 illustrates an example of a block diagram of a voting system configuration tool, in accordance with some example embodiments;

FIGS. 2-12A-B illustrate example pages that may be used in connection with the voting configuration process, in accordance with some example embodiments;

FIG. 13 illustrates a process flow for voting configuration, in accordance with some example embodiments;

FIG. 14 is an example voting process configured in accordance with the voting configurator disclosed herein; and

FIG. 15 is an example of an apparatus, in accordance with some example embodiments.

### DETAILED DESCRIPTION

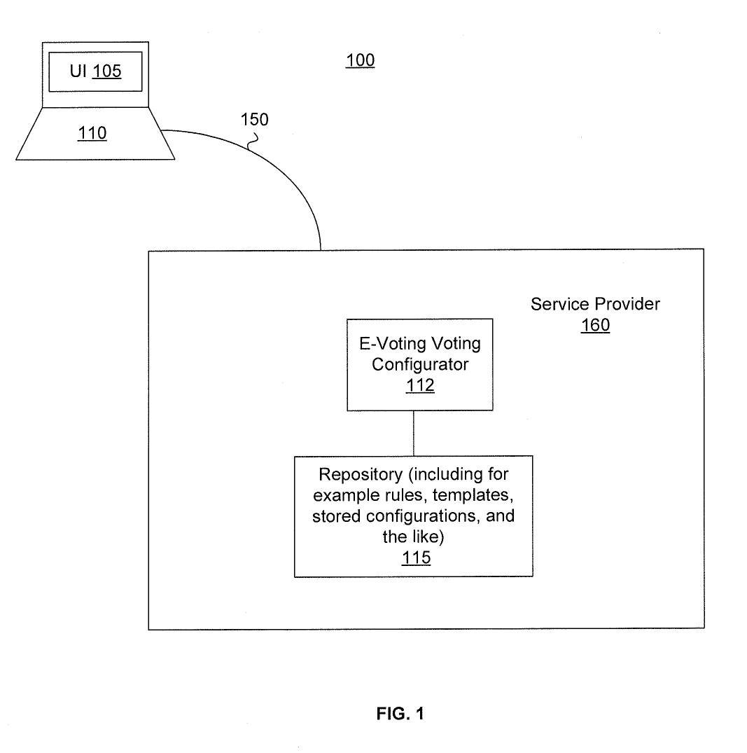

FIG. 1 depicts an example of a system 100 including a processor, such as computer 110 having a user interface 105. The computer 110 may be coupled via a network 150, such as the Internet, an intranet, and/or any other network or link, to a service provider 160. Service provider 160 may provide an electronic voting (e-voting) configurator 112, which is coupled to a repository 115.

In some example implementations, a user configuring an electronic voting process may access user interface 105. User interface 105 may include a browser or a client application configured to access, via network 150, service provider 160 in order to configure electronic voting. When accessed, the service provider 160 facilitates the configuration of the electronic voting process including the pages presented to the voter and the operations a voter is allowed to perform. To illustrate further, the e-voting configurator 112 may access templates, rules, code, and other metadata at repository 115 to configure the electronic voting process. Moreover, e-voting configurator 112 may generate pages (for example, hypertext markup lanaguge pages and the like), which when sent and presented at user interface 105, facilitate the configuration of the electronic voting process by a voter.

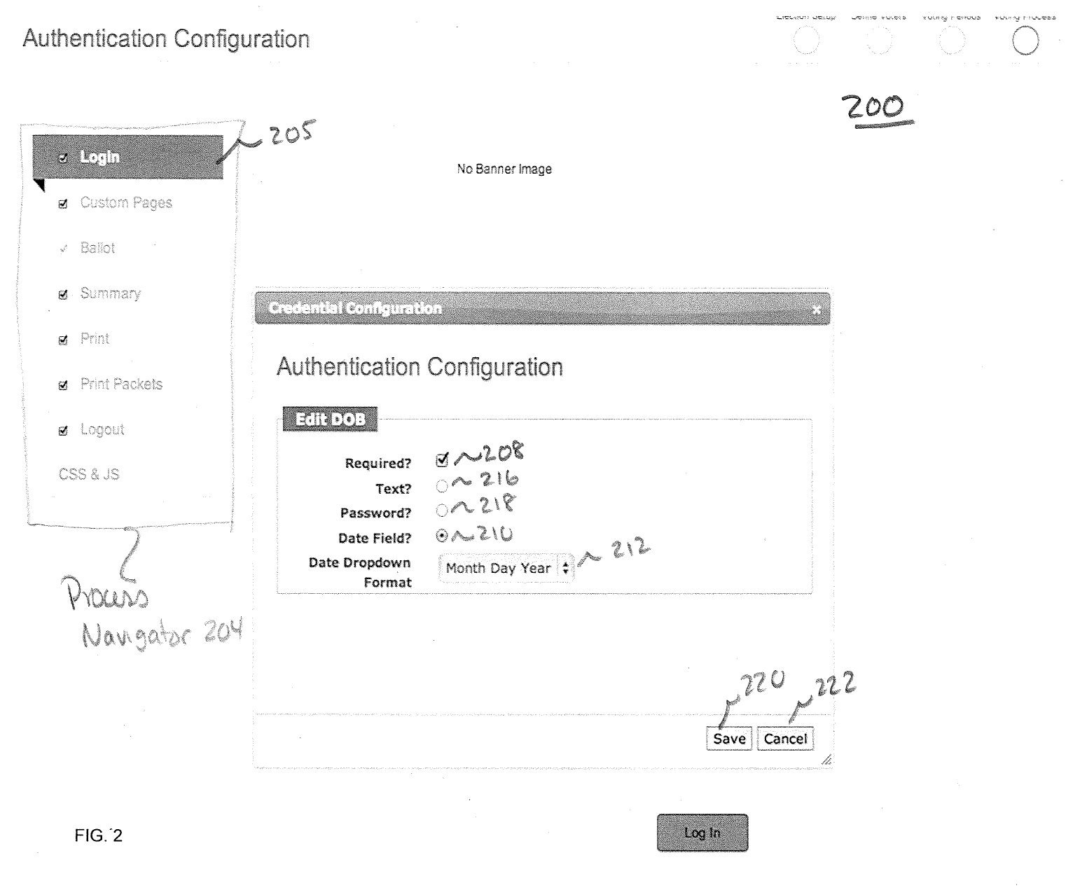

FIG. 2 depicts an example of a page 200 generated by e-voting configurator 112 and presented at user interface 105 to enable a user to configure an aspect of an electronic voting session. In the example of FIG. 2, the login phase 205 of the electronic voting session is being configured. The login phase allows a user to configure a voter's initial login to a voting session, during which the electronic voting will take place. For example, if a voter enters a polling station or votes from a home computer, the voter will likely be asked to login to begin the voting session. Page 200 may thus be used to configure what the voter sees and does during the voting session.

In the example of FIG. 2, if a user desires voter date of birth in order to login and start a voting session, the user selects required 208 to require a voter to provide a date of birth during the initial login to a voting session. Other authentication options include requiring a text 216 entry, such a first name and last name at login, requiring a password 218 at login, a date field 210 for the date of birth, and an input for mechanism 212 to be used by the voter (for example, a date dropdown element).

The repository 115 may include metadata, such as one or more templates, which can be selected by e-voting configurator 112 during the voting configuration process and presented as page 200 or an element of page 200, such as the selections 208-218. In some example implementations, e-voting configurator 112 may generate page 200 based on templates and rules tailored to a specific entity, jurisdiction, and/or election type. For example, when a user accesses service provider 160 and logins to service provider 160, service provider 160 including e-voting configurator 112 may access rules and or templates at repository 115 based on the identity of user/entity or that user's election type. For example, if a user/entity accessing via computer 110 service provider 160 may log in and indicates that an election is being configured for a certain jurisdiction, the e-voting configurator 112 may programmatically detect a rule at repository 115 indicating that the jurisdiction requires date of birth to login in order to vote. When this is the case, the rule may indicate to e-voting configurator 112 that a given template should be used to require a date field at page 200 to be selected. Although the previous example describes a rule requiring a date field at login, other rules may be used as well. Moreover, these rules may be specific to a user configuring voting, a jurisdiction, and/or any other entity. Further, these rules may be general as well so as to be allocable to a plurality of users, jurisdiction, and/or entities. Returning to the previous example, repository 115 may include a rule that states when a date field is selected or presented on page 200, a date drop down element must be presented on page 212 for selection.

Page 200 also includes a save 220 element and a cancel element 222. If the selections made at 208-218 are acceptable to the user configuring the voting session, then the configuration may be saved by selecting 220, in which case these setting are saved to repository 115. However, if the selections are not acceptable, the user may select cancel at 222 and exit or start the process over again.

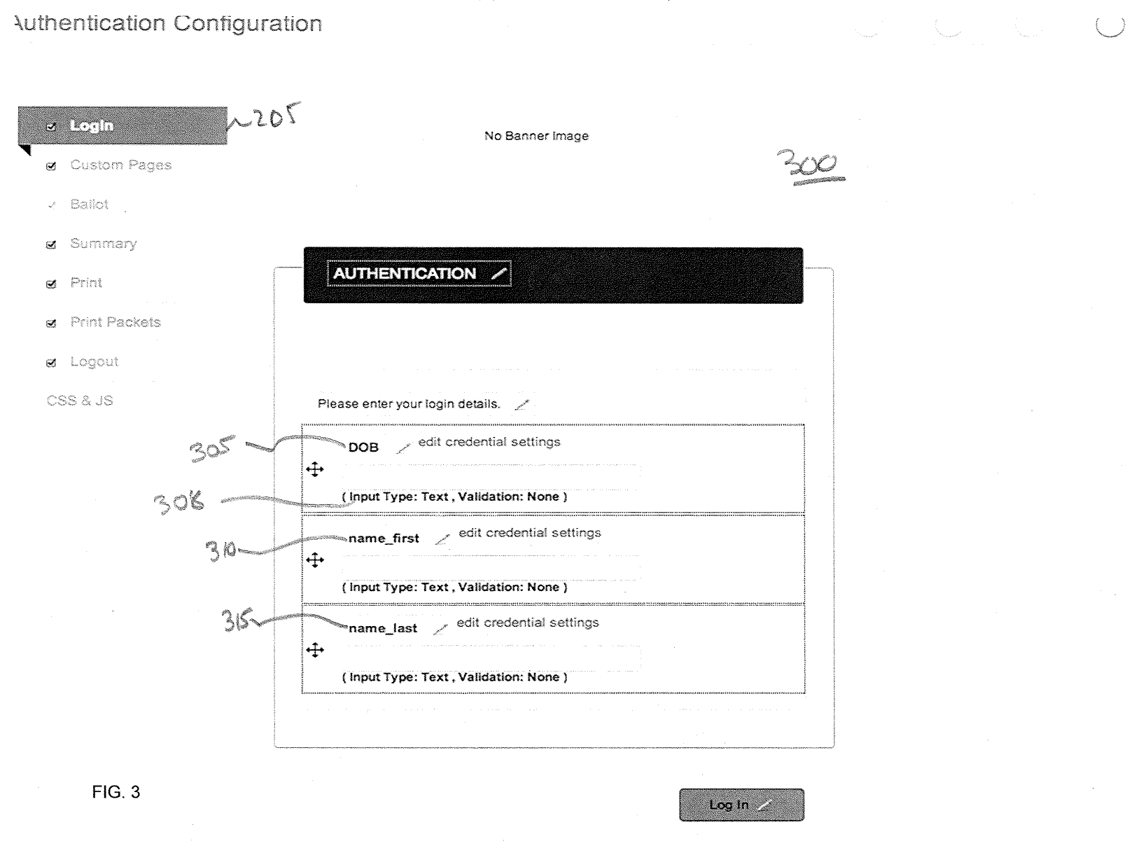

FIG. 3 depicts another example of a page 300 presented at user interface 105 to enable a user to configure an aspect of an electronic voting session. In the example of FIG. 3, the login phase 205 of the electronic voting session is also being configured. Specifically, e-voting configurator 112 generates page 300 to enable configuring the format of date of birth 305 field, which will be presented during a voter's login and the format of the first 310 and last 315 names used during a voter's login. Page 300 also enables defining a type 308 (which in this example is of type text) and whether the value provided at the given field should be validated for errors 309 (for example, if a date is expected but a value other than a date is provided by a voter, the validation 309 would flag an error to a voter and request correction).

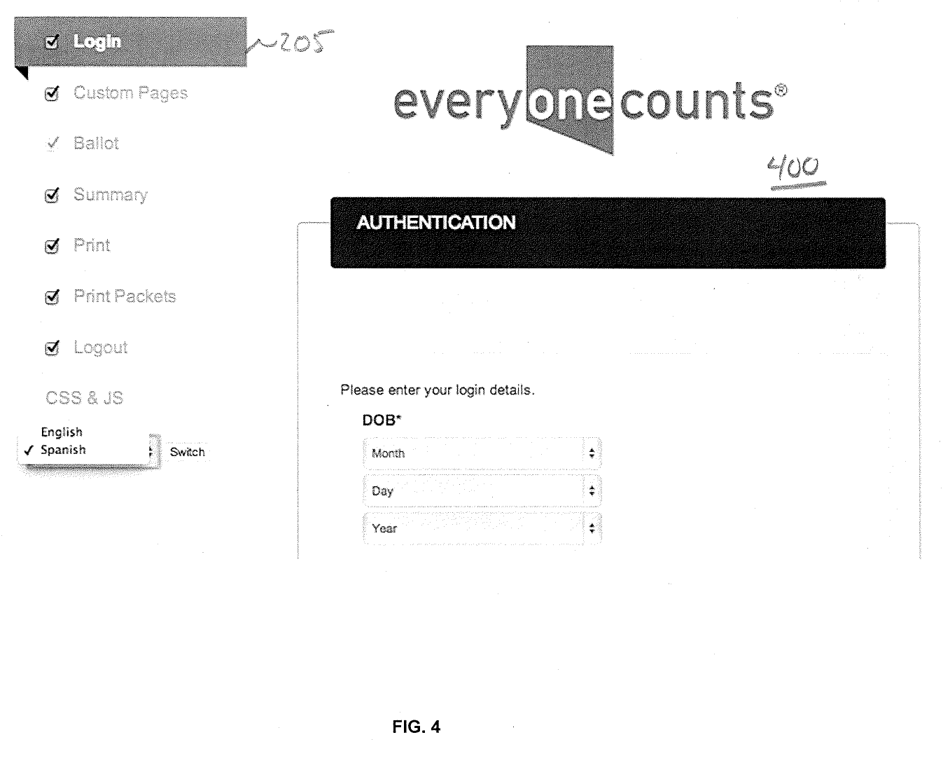

FIG. 4 depicts another example of a page 400 presented at user interface 105 to enable a user to configure the login phase 205 of the electronic voting session. In the example of page 400, it depicts a preview of the configured page, as it would appear during a voting session. For example, the date of birth required field 208 with a date drop down format 212 of FIG. 2 is previewed at 400 prior to saving the configuration at repository 115.

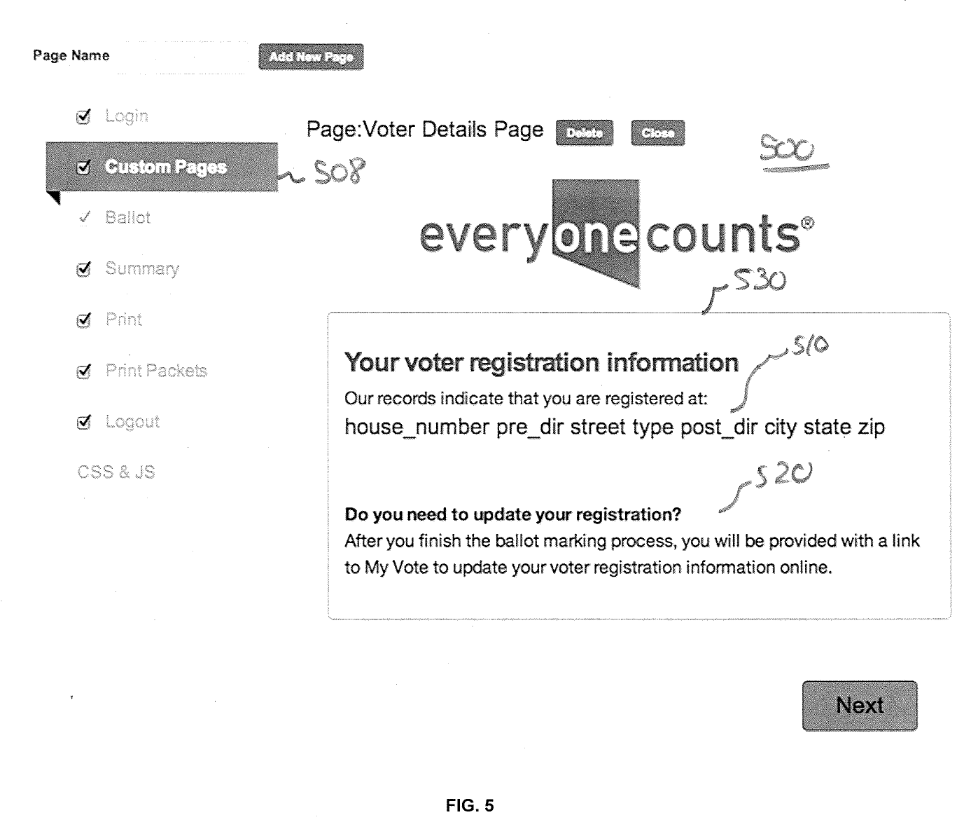

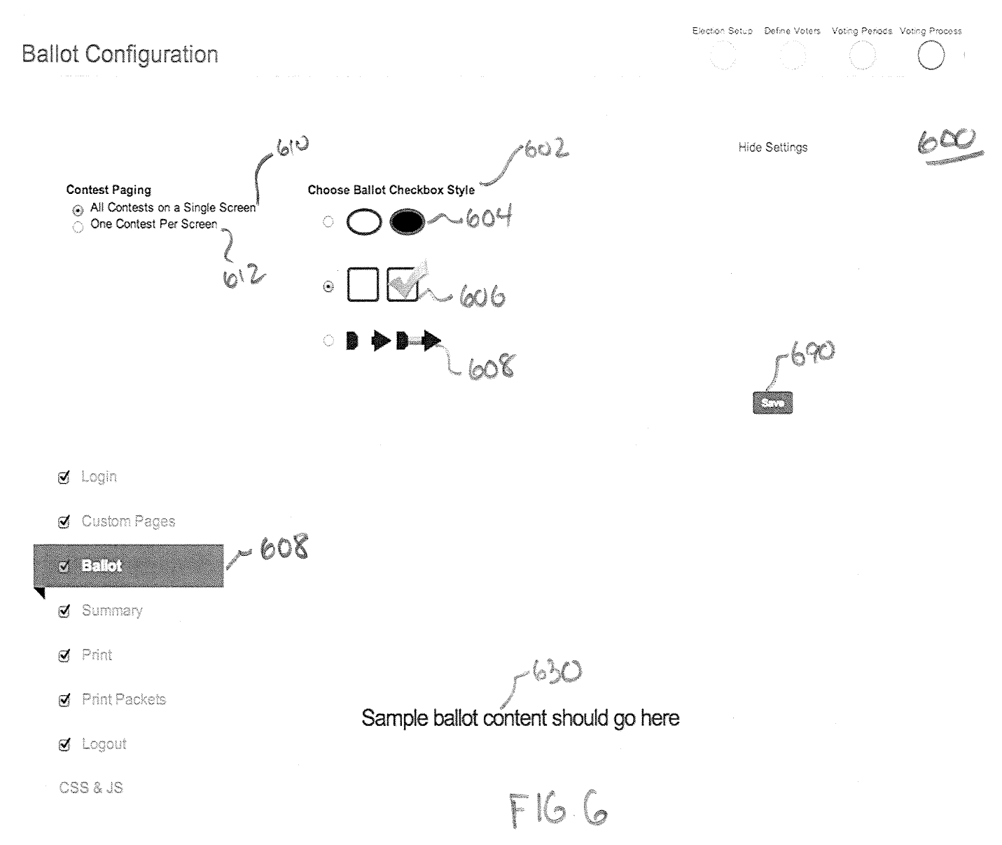

FIG. 5 depicts another example of a page 500 presented at user interface 105 to enable a user to configure custom pages 508 for use/viewing during a voter's electronic voting session. For example, custom pages 508 refer to custom pages that can be defined by the user at 105 for presentation during a voter during a voting session. For example, a user may define a custom page 530 providing a message 510 (which includes presenting the user's street address) and information 520 regarding how to update the voter's address.

In the example of page 500, e-voting configurator 112 may provide a template obtained from repository 115. This template may include a window 530 where custom pages for presentation to a voter may be configured. Custom pages may be saved in repository 115 for use during the voting session or as a template, which can be modified for other configured voting sessions.

In some example implementations, the e-voting configurator 112 may include a plurality of custom page templates that a user can select and use directly or with some modification to configure a voting session. Moreover, the e-voting configurator 112 may access templates based on the identity of the entity/user or jurisdiction. Further, the e-voting configuration may be used to define rules and store them at repository 115. For example, if a jurisdictions requires notifying a voter regarding updates to address information 520, the e-voting configuration 112 may provide that notification as a template, which can be configured at 530. This notification requirement may be saved as a rule at repository 115, and sent as a message to user interface 105 during configuration of the voting session.

FIG. 6 depicts another example of a page 600 presented at user interface 105 to enable a user to configure an electronic ballot 608. The page 600 may include selection of whether the voting session for a voter should have a given ballot style, such as check box style 602 (for example, ovals 604, checks 606, or arrows 608) and the like. The selection at 612 may configure whether each contest during a voter's voting session is separately presented on a single view/page or whether all the contests are listed on the same view/page 610. In the example of page 600, a user configuring the voting session may select that all contests to be voted on during the voter's voting session are to be presented on a single view/page 610.

Page 600 may also allow linking or including a sample ballot 630. Once the ballot is configured, the configuration may be saved at 690 to repository 115.

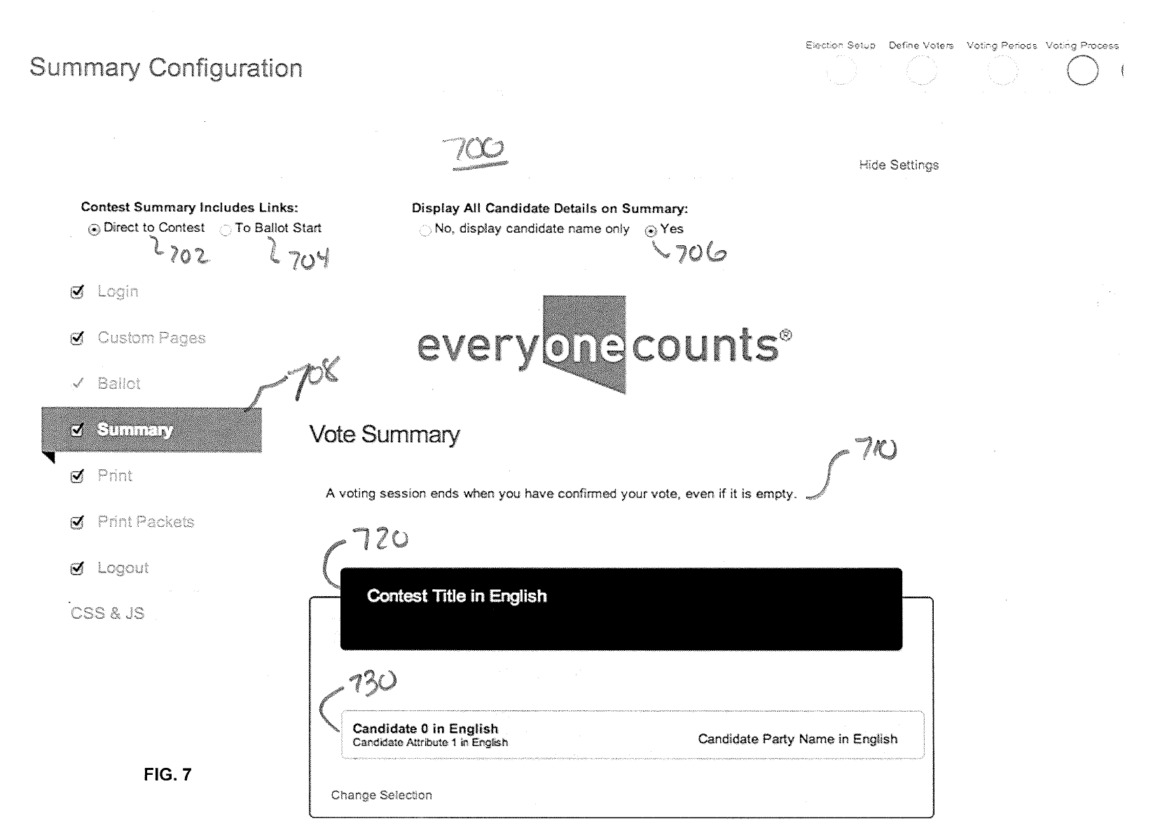

FIG. 7 depicts another example of a page 700 presented at user interface 105 to enable a user to configure a vote summary 708. The vote summary 708 refers voting summary information, such as names of candidates or propositions, details/description for the candidate/proposition, and any other voting summary information that can be presented to a user. In the example of FIG. 7, a user may select 702 to have a summary or instead select 704 to allow a voter to proceed directly to the contest(s)/voting without a vote summary. When 704 is selected, the user may configure, by selecting yes at 706, the voting summary to contain a list of the candidates (or items being voted on) and a brief description for each of the candidates/propositions or may configure, by selecting no at 707, a summary including a list candidate names/propositions being voted during the contest (without the brief description of each). In the example of FIG. 7, the voting summary includes a message 710 configured via user interface 105 to indicate to a voter that the electronic voting session ends when the vote is “confirmed.” The voting summary is also configured to include contest title 720.

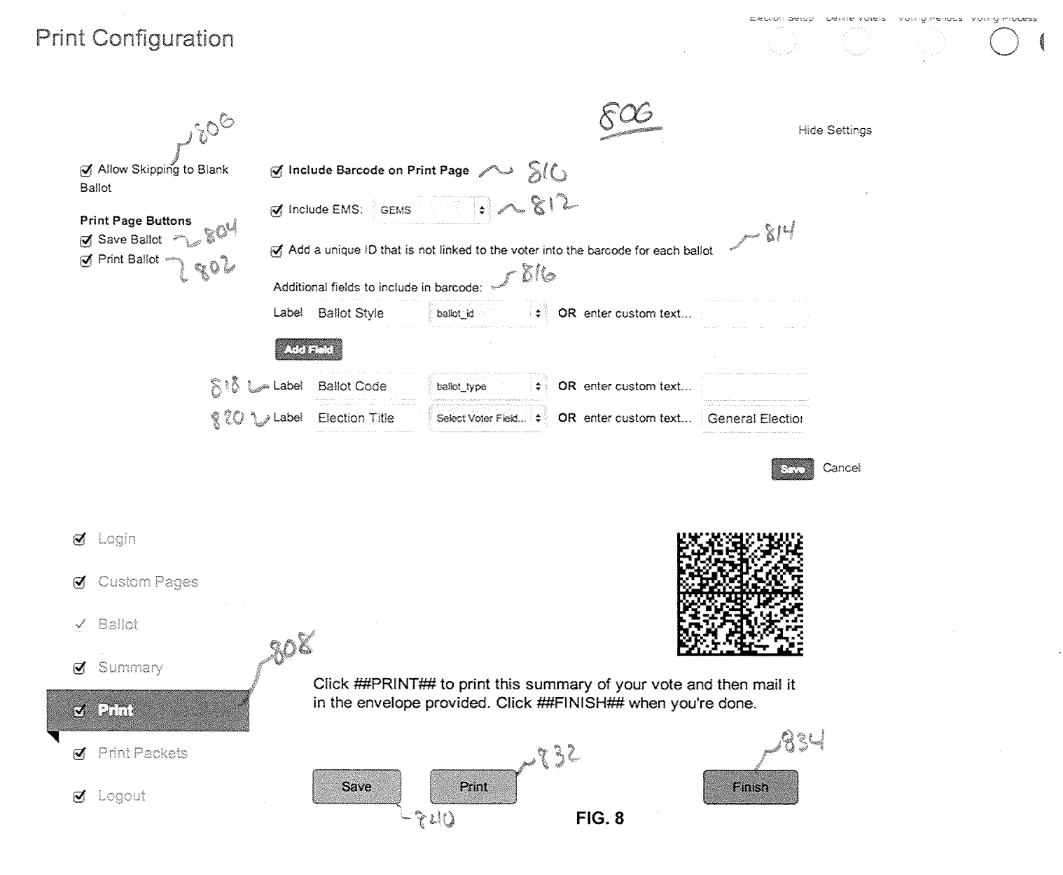

FIG. 8 depicts another example of a page 800 presented at user interface 105 to enable a user to configure what, if anything, a voter can print and in what format during an electronic voting session. For example, a user may configure via page 800 whether during the electronic voting session a voter can print a ballot 802 (for example, to keep a sample of the selections made by the voter), save a ballot, and/or print a blank ballot 806. The page 800 may also allow configuration of one or more of the following: whether a bar code 810 will be printed; whether an election management system (EMS) 812 will be included; whether a voter unique identifier will be printed 814; or whether additional fields 816-820 will be printed as well. Moreover, a message for presentation to the voter during the voting session may be configured as well at 830. If the print configuration is complete, the user may save at 840 the configuration to repository 115.

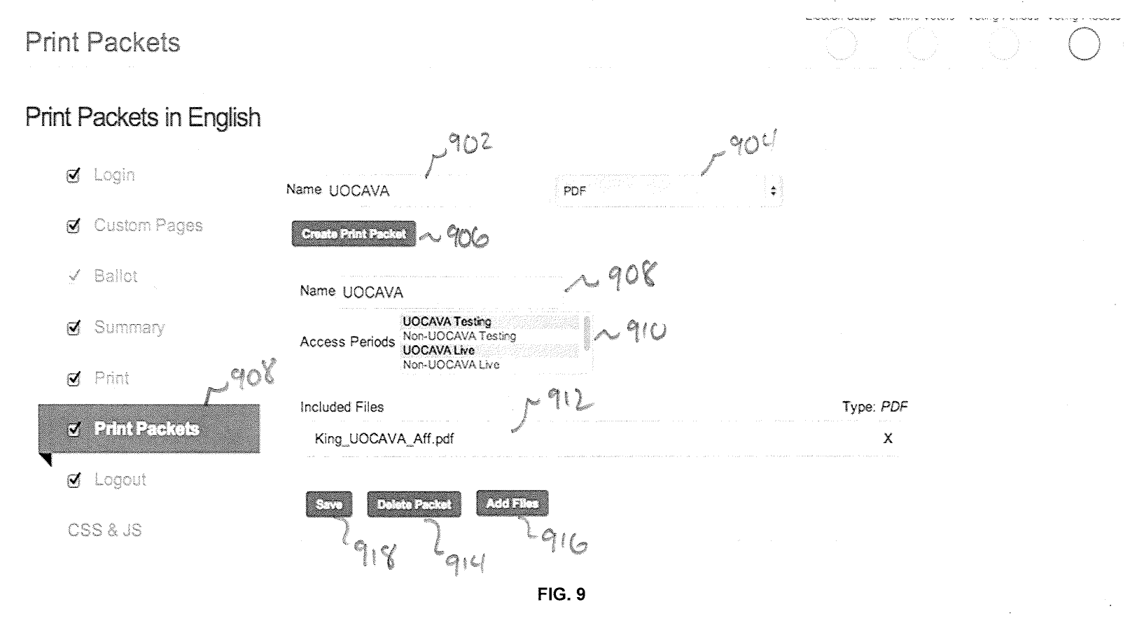

FIG. 9 depicts another example of a page 900 presented at user interface 105 to enable a user to configure whether the voter can print a voter's packet 908. In some jurisdictions, a voter may not be allowed to print a copy of what the voter selected. When this is the case, a rule at repository 115 may be defined to prevent a user for those jurisdictions from allowing voters to print their selections during a voting session.

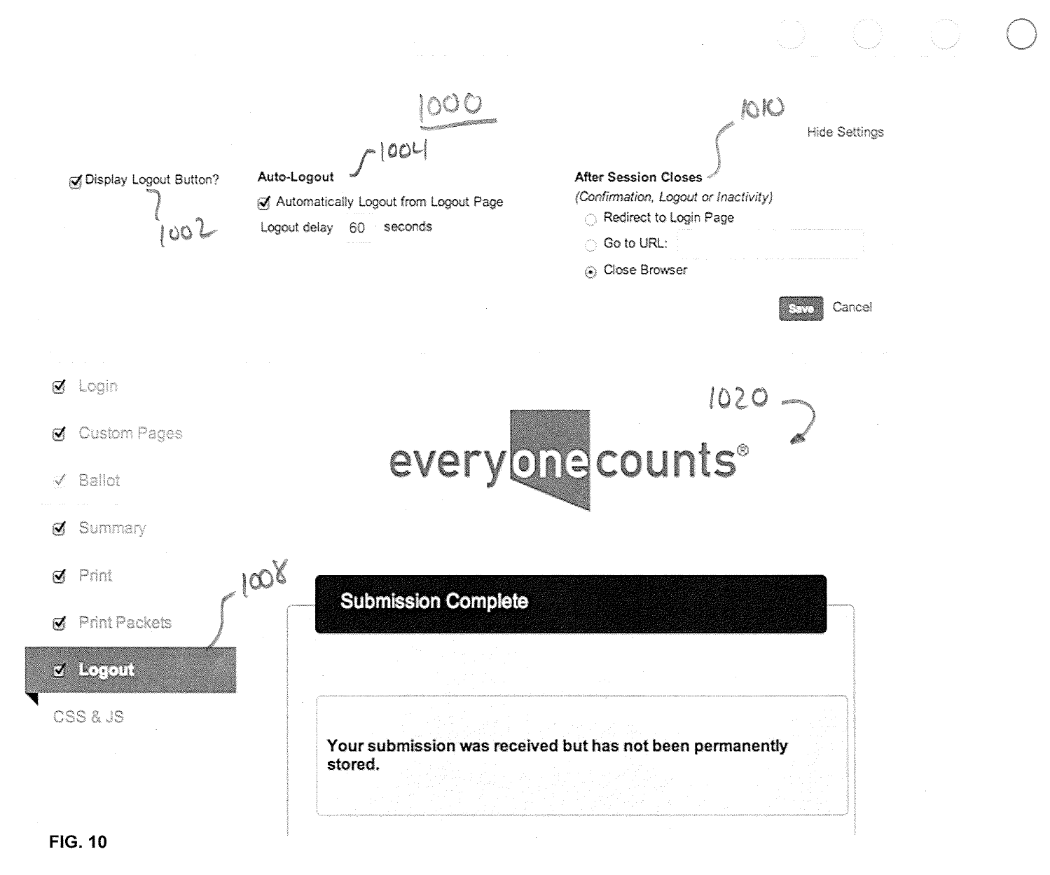

FIG. 10 depicts an example of a page 1000 presented at user interface 105 to enable a user to configure an aspect of an electronic voting session. In the example of FIG. 10, the logout 1008 of the electronic voting session is configured. The logout phase allows a user to configure how a voter completes the voting session. For example, the page may allow configuration of whether a logout button is presented to a voter 1002 to confirm and complete voting, whether a voter can be automatically logged 1004 out after a certain period of time due to inactivity, and/or what happens 1010 after confirmation, logout, and/or inactivity (for example, redirect to another login page, go to a specific URL, or close the voter's client application/browser). In the example of FIG. 10, 1020 shows that when a voting session closes, the voter's browser/client application closes.

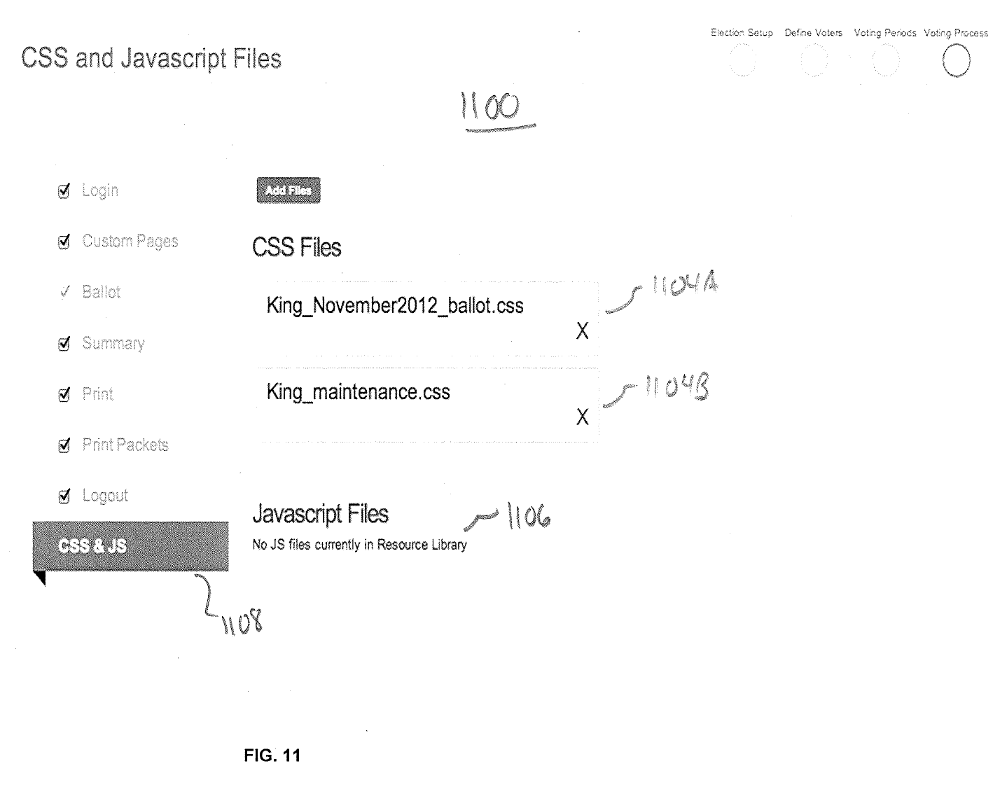

FIG. 11 depicts a page 1100 which can be presented at user interface 105 to allow associating data, such as files, formats, executable (for example, Javascript and the like), and metadata to an electronic voting session. For example, a certain ballot style may be selected at 1104A-B to define the look and feel of the ballots presented to a voter during the electronic voting session. Moreover, an executable file may be associated at 1106 as well. For example, a script may be associated at 1106 to provide printing, query a voter database for voter credentials including name, address and the like, and/or any other operation which may be required and thus configured or the electronic voting session.

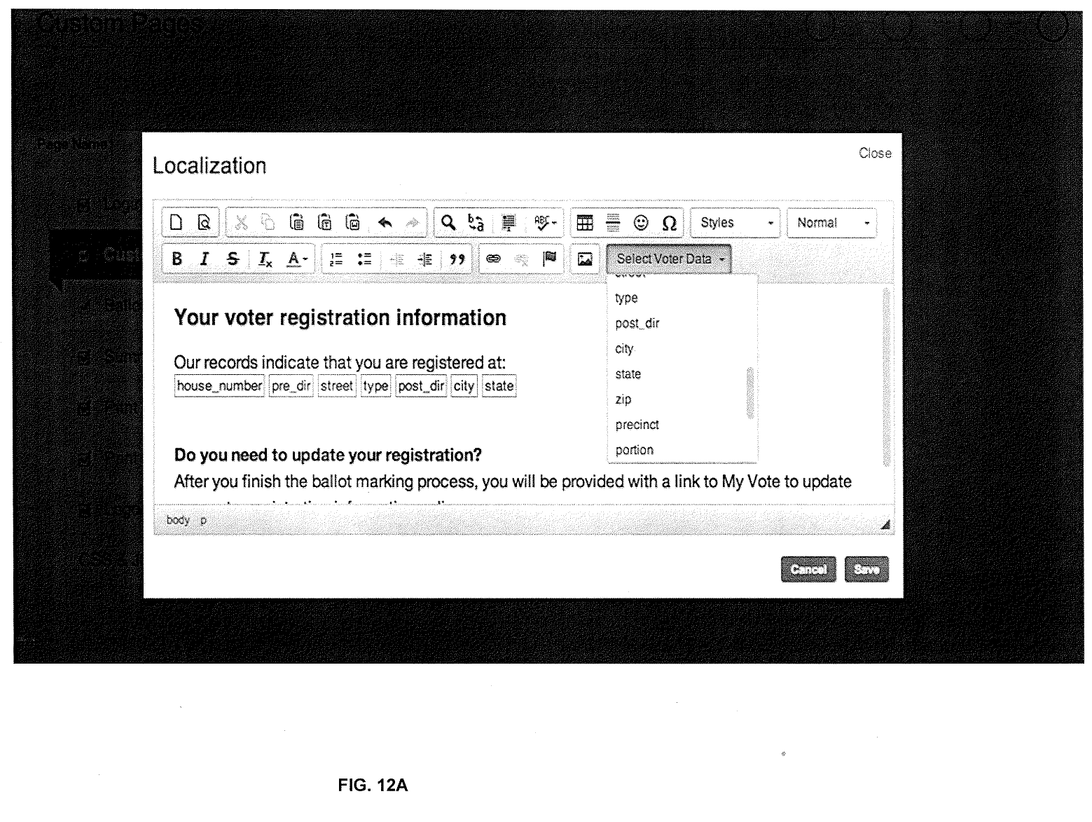

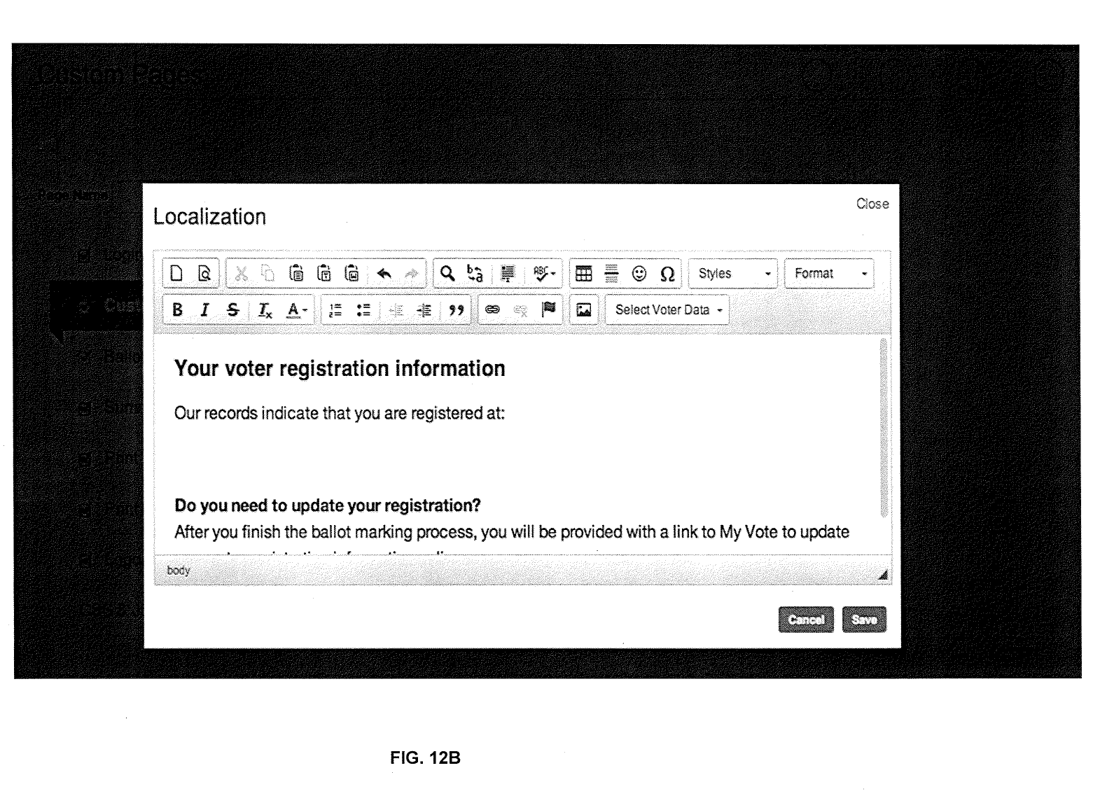

FIG. 12A-B depicts user interfaces where localization can be performed.

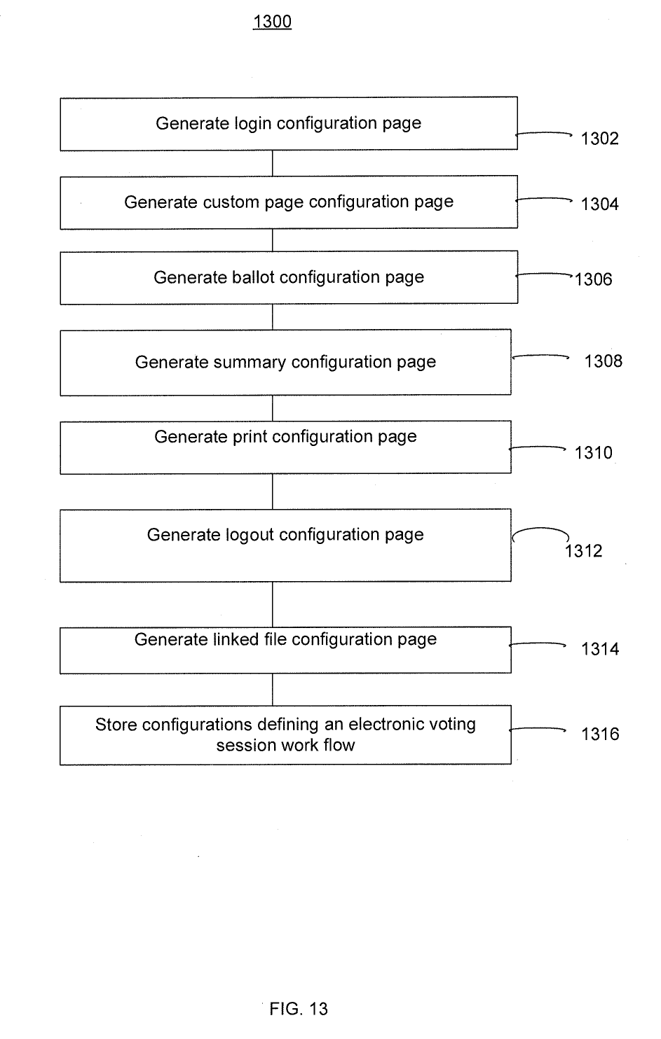

FIG. 13 depicts a process 1300 for configuring an electronic voting session.

At 1302, an electronic voting configurator 112 may generate a page, such as page 200, to allow configuration of the login process used by a voter during an electronic voting session. For example, electronic voting configurator 112 may access from repository 115 a template and present the template as for example pages 200 and 300 to allow a user to configure an electronic voting session. To illustrate further, a selection of date of birth required at 208 may modify the template. In any case, modifications made to page 200 and selections made to page 200 may be saved to repository 220.

At 1304, an electronic voting configurator 112 may generate a page, such as page 500, to allow configuration of custom pages for presentation to a voter during electronic voting. For example, electronic voting configurator 112 may access from repository 115 a template having the format and allowed operations for the custom pages. This template may be presented as for example page 500 to allow configuration for the electronic voting session. In the example of FIG. 5 at page 500, the configuration includes providing at 530 specific information to the voters during the voting session.

At 1306, an electronic voting configurator 112 may generate a page, such as page 600, to allow ballot configuration for use by a voter during an electronic voting session. Electronic voting configurator 112 may, for example, access from repository 115 a template having the format and allowed operations for ballot configuration. This template may be presented as for example page 600 to allow ballot configuration for the electronic voting session. The configuration made at 1306 may be saved at repository 115 for subsequent use.

At 1308, electronic voting configurator 112 may generate a page, such as page 700, to allow configuration of summary information, which can be presented to a voter during an electronic voting session. Electronic voting configurator 112 may, for example, access from repository 115 a template having the format and allowed operations for voting summary information. This template may be presented as for example page 700 to allow voting summary configuration for the electronic voting session. In the example of FIG. 7, the configuration may include determining whether voting summary information can be presented and the form/format of the voting summary, as noted above with respect to FIG. 7.

At 1310, electronic voting configurator 112 may generate a page, such as pages 800 and 900, to allow configuration of print processes during an electronic voting session. Electronic voting configurator 112 may, for example, access from repository 115 one or more templates, which may presented as for example pages 800 and/or 900 to configure the printing related operations associated an electronic voting session.

At 1312, an electronic voting configurator 112 may generate a page, such as page 1000, to allow configuration of the logout process used by a voter during electronic voting session. For example, electronic voting configurator 112 may access from repository 115 one or more templates, which may be presented as for example page 1000 to configure the logout, which completes the voter's voting session. For example, after the voting session is terminated, the vote may be printed as a cast ballot and/or forwarded for tallying (either electronically, mechanically, and/or in other ways as well).

At 1314, an electronic voting configurator 112 may generate a page, such as page 1100, to allow configuration of linking files, executable scripts, and other data to a an electronic voting session. For example, electronic voting configurator 112 may access from repository 115 a template, which may be presented as for example page 1100, where files 1104A-B, 1106, and the like can be linked and thus applied during an electronic voting session.

At 1316, the configurations made at 1302-1314 may be stored in repository 115 to define the voting work flow for a voter during a voting session. For example, the login configuration (1302) and so forth may be saved repository 115 to define the work flow at a voting session. Moreover, the stored configuration may be stored and used to define the pages and operations used during the voting work flow during an electronic voting session (for example, the views presented and required operations a voter performs to vote). To illustrate further, the configurations defined by process 1300 may define a model used to generate the views presented as pages to a voter during an electronic voting session, and the model may also define the operations allowed to be performed by the voter.

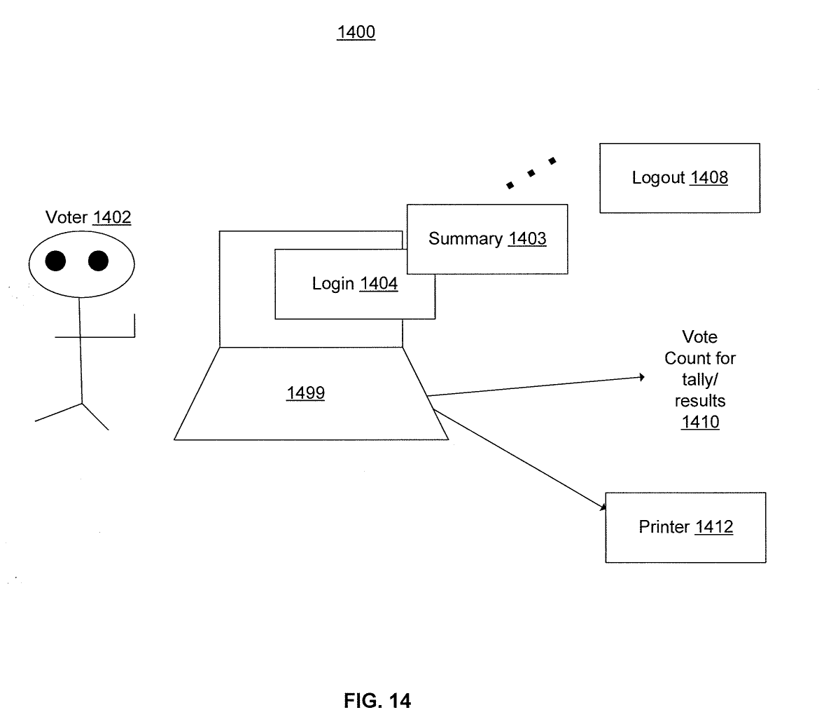

FIG. 14 depicts an example of an electronic voting session 1400 configured by process 1300 and system 100. In the example of FIG. 14, a voter 1402 approaches a processor 1499. In some implementations, processor 1499 may be the voter's own computer, such as in the case of electronic absentee voting, but in other implementations, the processor 1499 may be a voting kiosk as found in a polling station (which may actually include a plurality of processor-based electronic voting kiosks).

When voter 1402 accesses processor 1499, a page 1404 is presented to allow a user to login. The login page 1404 and the fields (which the voter is required to provide in order to vote) may be configured by e-voting configurator 112 as noted above with respect to page 200 and 1302.

In some example implementations, e-voting configurator 112 configured the entire electronic voting session work flow from for example initial login 1404 to start the voting session, whether summary information is presented to a voter 1403 as described 1308, how the ballot is presented 1404 as described at 1306, the logout 1408 process (which may cast the ballot at 1410, when the voter so chooses), whether (as well as how and what) can be printed 1412, and any other aspect of the electronic voting session and the associated work flow, user-experience, and any other aspect of the electronic voting session. The e-voting configurator 112 may thus configure the workflow using templates defining aspects of the voting process that can or should be included to facilitate the configuration. The e-voting configurator 112 may also use rules to allow the proper configuration in accordance with, for example, a jurisdiction's laws or policy.

In some example implementations, process 200 may enable an entity to generate a variety of ballots without hardcoding or understanding the underlying metadata as the service provider handles importation, mapping, and the like for a variety of different types of EMS data. Moreover, service provider 160 may be implemented as a centralized service or cloud service (for example, software as a service). When this is the case, the service provider 160 can maintain accurate metadata for the EMS data types including revision thereto and offer a plurality of predetermined templates for use users.

In some example implementations, service provider 160 may be implemented as a software as a service provider, so execution of the e-voting configurator 112 is in the cloud (for example, a server at a website accessible and/or shared by other users).

Although FIG. 1 depicts a single computer 110 and a single service provider 160, other quantities and configurations of system 100 may be implemented as well.

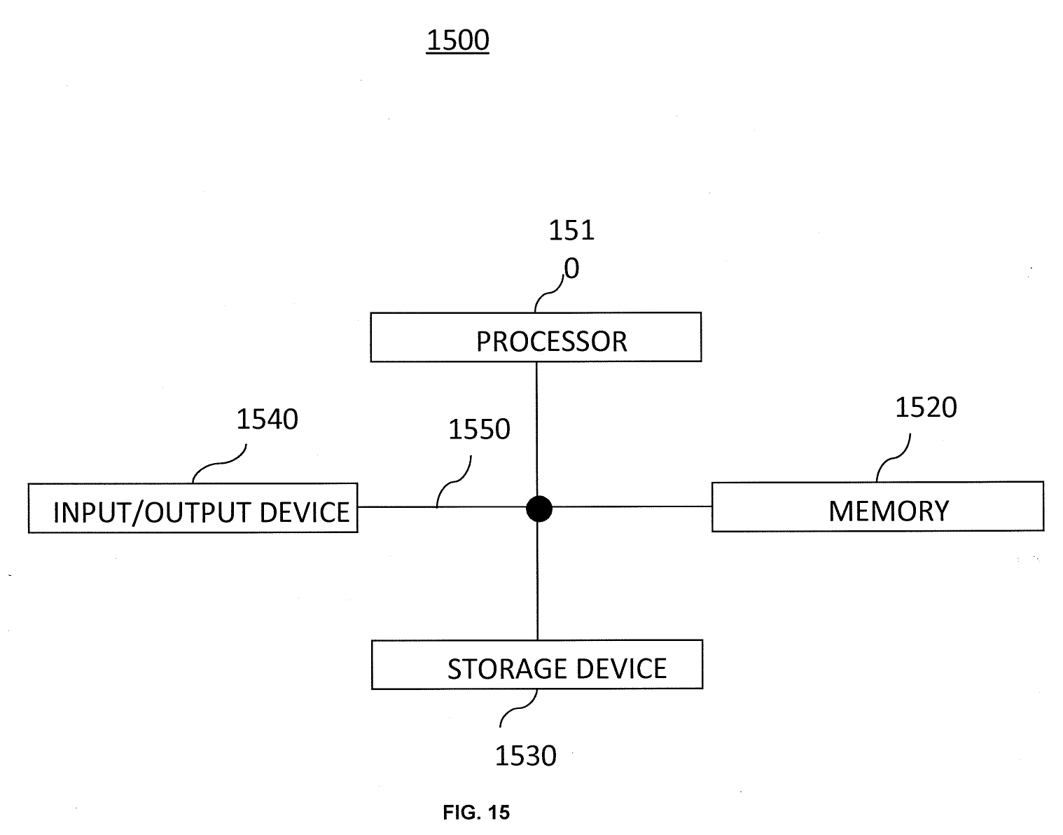

FIG. 15 depicts an example of a system, which can be used as the computer 115 or as a host for service provider 160. The system 1500 can include a processor 1510, a memory 1520, a storage device 1530, and an input/output device 1540. Each of the components 1510, 1520, 1530 and 1540 can be interconnected using a system bus 1550. The processor 1510 can be configured to process instructions for execution within the system 1500. In some implementations, the processor 1510 can be a single-threaded processor. In alternate implementations, the processor 1510 can be a multi-threaded processor. The processor 1510 can be further configured to process instructions stored in the memory 1520 or on the storage device 1530, including receiving or sending information through the input/output device 1540. The memory 1520 can store information within the system 1500. In some implementations, the memory 1520 can be a computer-readable medium. In alternate implementations, the memory 1520 can be a volatile memory unit. In yet some implementations, the memory 1520 can be a non-volatile memory unit. The storage device 1530 can be capable of providing mass storage for the system 1500. In some implementations, the storage device 1530 can be a computer-readable medium. In alternate implementations, the storage device 1530 can be a floppy disk device, a hard disk device, an optical disk device, a tape device, non-volatile solid-state memory, or any other type of storage device. The input/output device 1540 can be configured to provide input/output operations for the system 1500. In some implementations, the input/output device 1540 can include a keyboard and/or pointing device. In alternate implementations, the input/output device 1540 can include a display unit for displaying graphical user interfaces.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. As used herein, the term “user” can refer to any entity including a person or a computer. Other implementations may be within the scope of the following claims.

What is claimed:

1. A method comprising:
configuring, by an electronic voting configurator, an electronic voting session including operations permitted by a voter and one or more pages presented to the voter during the electronic voting session, wherein the configuring further includes:
receiving a first selection from a user interface including a login configuration page enabling configuration of a login for the voter during the electronic voting session,
receiving a second selection from the user interface including a ballot configuration page enabling configuration of a ballot for presentation to the voter during the electronic voting session,
receiving a third selection from the user interface including a print configuration page enabling configuration of whether printing is allowed by the voter during the electronic voting session, and
receiving a fourth selection from the user interface including a logout configuration page enabling configuration of a logout for the voter during the electronic voting session; and
storing, by the electronic voting configurator, the first, second, third, and fourth selections in a repository to define the operations permitted by the voter and the one or more pages presented to the voter during the electronic voting session.

2. The method of claim 1 further comprising:
generating the login configuration page including a process navigator element to indicate a current state of the configuring; and
providing the generated login configuration page including the process navigator element to the user interface to enable the first selection.

3. The method of claim 1 further comprising:
generating the ballot configuration page including a process navigator element to indicate a current state of the configuring; and
providing the generated ballot configuration page including the process navigator element to the user interface to enable the second selection.

4. The method of claim 1 further comprising:
generating the print configuration page including a process navigator element to indicate a current state of the configuring; and
providing the generated print configuration page to the user interface to enable the third selection.

5. The method of claim 1 further comprising:
generating the logout configuration page including a process navigator element to indicate a current state of the configuring; and
providing the generated logout configuration page including the process navigator element to the user interface to enable the third selection.

6. The method of claim 1, wherein the electronic voting configurator comprises a web service.

7. The method of claim 1, wherein the electronic voting configurator comprises at least one processor and at least one memory.

8. The method of claim 1, wherein the user interface comprises a display.

9. An apparatus comprising:
at least one processor; and
at least one memory including computer program code, the at least one memory and the computer program code configured to, with the at least one processor, cause the apparatus to perform at least the following:
configure, by the apparatus, an electronic voting session including operations permitted by a voter and one or more pages presented to the voter during the electronic voting session, wherein the configuring further includes:
receive a first selection from a user interface including a login configuration page enabling configuration of a login for the voter during the electronic voting session,
receive a second selection from the user interface including a ballot configuration page enabling configuration of a ballot for presentation to the voter during the electronic voting session,
receive a third selection from the user interface including a print configuration page enabling configuration of whether printing is allowed by the voter during the electronic voting session, and
receive a fourth selection from the user interface including a logout configuration page enabling configuration of a logout for the voter during the electronic voting session; and
store, by the apparatus, the first, second, third, and fourth selections in a repository to define the operations permitted by the voter and the one or more pages presented to the voter during the electronic voting session.

10. The apparatus of claim 9 further comprising:
generate the login configuration page including a process navigator element to indicate a current state of the configuring; and
provide the generated login configuration page including the process navigator element to the user interface to enable the first selection.

11. The apparatus of claim 9 further comprising:
generate the ballot configuration page including a process navigator element to indicate a current state of the configuring; and
provide the generated ballot configuration page including the process navigator element to the user interface to enable the second selection.

12. The apparatus of claim 9 further comprising:
generate the print configuration page including a process navigator element to indicate a current state of the configuring; and
provide the generated print configuration page to the user interface to enable the third selection.

13. The apparatus of claim 9 further comprising:
generate the logout configuration page including a process navigator element to indicate a current state of the configuring; and
provide the generated logout configuration page including the process navigator element to the user interface to enable the third selection.

14. The method of claim 1 further comprising:
generate the logout configuration page including a process navigator element to indicate a current state of the configuring; and
provide the generated logout configuration page including the process navigator element to the user interface to enable the third selection.

15. A non-transitory computer-readable medium including program code which when executed by at least one process causes operations comprising:
configuring, by an electronic voting configurator, an electronic voting session including operations permitted by a voter and one or more pages presented to the voter during the electronic voting session, wherein the configuring further includes:
receiving a first selection from a user interface including a login configuration page enabling configuration of a login for the voter during the electronic voting session,
receiving a second selection from the user interface including a ballot configuration page enabling configuration of a ballot for presentation to the voter during the electronic voting session,
receiving a third selection from the user interface including a print configuration page enabling configuration of whether printing is allowed by the voter during the electronic voting session, and
receiving a fourth selection from the user interface including a logout configuration page enabling configuration of a logout for the voter during the electronic voting session; and
storing, by the electronic voting configurator, the first, second, third, and fourth selections in a repository to define the operations permitted by the voter and the one or more pages presented to the voter during the electronic voting session.

16. The non-transitory computer-readable medium claim 15 further comprising:
generating the login configuration page including a process navigator element to indicate a current state of the configuring; and
providing the generated login configuration page including the process navigator element to the user interface to enable the first selection.

17. The non-transitory computer-readable medium claim 15 further comprising:
generating the ballot configuration page including a process navigator element to indicate a current state of the configuring; and
providing the generated ballot configuration page including the process navigator element to the user interface to enable the second selection.

18. The non-transitory computer-readable medium claim 15 further comprising:
generate the print configuration page including a process navigator element to indicate a current state of the configuring; and
provide the generated print configuration page including the process navigator element to the user interface to enable the third selection.

19. The non-transitory computer-readable medium claim 15 further comprising:
generate the logout configuration page including a process navigator element to indicate a current state of the configuring; and
provide the generated logout configuration page including the process navigator element to the user interface to enable the third selection.
